(19) United States
(12) Patent Application Publication
(10) Pub. No.: US 2026/0294736 A1
(43) Pub. Date: Oct. 1, 2026

(54) SYSTEM AND METHOD FOR SUPPRESSING VERTIGO OR MOTION SICKNESS

(71) Applicants: Cochlear Limited, Macquarie University, NSW (AU); Universidad de las Palmas de Gran Canaria, Las Palmas de Gran Canaria (ES)

(72) Inventors: Koen Erik Van den Heuvel, Hove (BE); Sören Nilsson, Kungälv (SE); Erika Van Baelen, Rotselaar (BE); Wim Bervoets, Wilrijk (BE); Angel Ramos de Miguel, Las Palmas de Gran Canaria (ES)

(21) Appl. No.: 19/479,696

(22) PCT Filed: Apr. 9, 2024
(86) PCT No.: PCT/IB2024/053458

§ 371 Date: Oct. 28, 2025

(30) Foreign Application Priority Data
May 5, 2023 (EP) 23382419.2

(51) Int. Cl. A61H 23/02

(52) U.S. Cl. CPC A61H 23/02; A61H 2201/0153; A61H 2201/1207; A61H 2201/1604; A61H 2201/1657; A61H 2201/5005

(57) ABSTRACT

An apparatus includes a housing configured to be held in a recipient's hand and at least one actuator contained within the housing. The at least one actuator is configured to generate vibrations. The apparatus further includes at least one element in mechanical communication with the at least one actuator and extending from a portion of an outer surface of the housing. The at least one element is configured to receive the vibrations from the at least one actuator, to be pressed against a portion of the recipient's head by a recipient generated force, and to transmit the vibrations to the recipient's head.

### BACKGROUND

The project leading to this application has received funding from the European Union's Horizon 2020 research and innovation programme under grant agreement No 801127.

### FIELD

The present application relates generally to systems and methods for suppressing vertigo or motion sickness by applying vibrations to the recipient's head.

### DESCRIPTION OF THE RELATED ART

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises a housing configured to be held in a recipient's hand and at least one actuator contained within the housing. The at least one actuator is configured to generate vibrations. The apparatus further comprises at least one element in mechanical communication with the at least one actuator and extending from a portion of an outer surface of the housing. The at least one element is configured to receive the vibrations from the at least one actuator, to be pressed against a portion of the recipient's head by a recipient-generated force, and to transmit the vibrations to the recipient's head.

In another aspect disclosed herein, an apparatus comprises a handheld vibrator configured to generate vibrations in response to the vibrator being pressed against a recipient's head and to not generate the vibrations in response to the vibrator not being pressed against the recipient's head. The vibrator comprises a switch configured to switch the vibrator between an active state in which the vibrator generates the vibrations and an inactive state in which the vibrator does not generate the vibrations.

In another aspect disclosed herein, a method comprises providing at least one vibration generator configured to be pressed against a head of a recipient. The method further comprises pressing the at least one vibration generator against the head. The method further comprises, while the at least one vibration generator is pressed against the head, transmitting vibrations from the at least one vibration generator simultaneously and substantially equally to bilateral portions of the recipient's vestibular system.

### BRIEF DESCRIPTION OF THE DRAWINGS

Implementations are described herein in conjunction with the accompanying drawings, in which:

FIG. 1 shows a cross-sectional view cut in the mid-modiolar axial plane of the vestibular system in accordance with certain implementations described herein;

FIGS. 2A and 2B schematically illustrate a cross-sectional view and a side view, respectively, of an example apparatus in accordance with certain implementations described herein;

FIGS. 3A-3C schematically illustrate the apparatus pressed against various example portions of the recipient's head in accordance with certain implementations described herein;

FIGS. 4A-4G schematically illustrate side views of various example apparatus having various second end portions of the at least one element compatible with certain implementations described herein;

FIG. 4H schematically illustrates a top view of an example apparatus having a second end portion comprising a mouthpiece in accordance with certain implementations described herein; and

FIG. 5 is a flow diagram of an example method in accordance with certain implementations described herein.

### DETAILED DESCRIPTION

The vestibular system is a portion of the inner ear which enables the sensation of angular and linear motion. Neural signals corresponding to this sensed motion are used by the brain to assist in a variety of processes including balance and determining orientation, and in related motor activities such as walking, standing, and visual orientation.

Various dysfunctions and abnormalities of the vestibular system are known, and in severe cases they can result in significant disability for those so afflicted. In older persons, the loss of stability attendant upon vestibular dysfunction can lead to a greatly increased likelihood of a fall, and consequent loss of independence and mobility. Meniere's disease is an abnormality of the vestibular system which affects approximately 1 in 2000 people worldwide. Meniere's disease has symptoms that are highly variable between patients, and it can be relatively difficult to diagnose with certainty. The symptoms of Meniere's disease include but are not limited to: periodic episodes of rotary vertigo or dizziness; fluctuating, progressive, unilateral or bilateral hearing loss; unilateral or bilateral tinnitus; and a sensation of fullness or pressure in one or both ears.

Approximately 85% of affected people affected by Meniere's disease can be treated with measures such as medication, dietary changes, lifestyle changes, or behavioral therapy. The remaining 15% of affected people are not assisted sufficiently by these measures, and turn to one of a variety of surgical procedures. For example, a vestibular stimulator system can be configured to provide electrical stimulations (e.g., using electrodes external to the recipient's body or implanted on or within the recipient's body) in order to treat vestibular disease.

Certain implementations described herein provide a non-invasive system and method for providing vibrational stimulation signals to the cochleovestibular system (e.g., the vestibule; vestibular nerve; cochlea) to reduce (e.g., suppress; alleviate) at least one condition (e.g., symptom) of vertigo or motion sickness. The system can include an actuator configured to generate low frequency vibrations (e.g., in a range of 10 Hz to 200 Hz) and having a relatively small form factor (e.g., configured to be handheld; a size and shape similar to that of a vape pen). The actuator is configured to be in mechanical communication with a portion of the recipient's head (e.g., pressed against the recipient's temple, jaw, or teeth; compressed between or bitten by the recipient's upper and lower teeth) so as to deliver the low frequency vibrations through the recipient's tissue to the cochleovestibular system. The vibrations can have a predetermined (e.g., preset) fixed frequency range or the vibrations can have an adjustable frequency range (e.g., adjusted prior to or during delivery of the low frequency vibrations. The actuator can be turned on by being pressed against the recipient's head with a pressure greater than a predetermined threshold or by an on/off button.

The teachings detailed herein are applicable, in at least some implementations, to any type of non-invasive medical device configured to apply vibrational stimulation signals to a portion of the recipient's body (e.g., head; skull; scalp). Implementations can include any type of medical device that can utilize the teachings detailed herein and/or variations thereof.

Merely for ease of description, apparatus and methods disclosed herein are primarily described with reference to an illustrative medical device for treating vertigo or motion sickness. However, the teachings detailed herein and/or variations thereof may also be used with a variety of other medical devices that provide a wide range of therapeutic benefits to recipients, patients, or other users. In some implementations, the teachings detailed herein and/or variations thereof can be utilized in other types of non-invasive medical devices. In some implementations, the non-invasive medical device can be used in conjunction with an implantable medical device. For example, apparatus and methods disclosed herein and/or variations thereof may also be used with one or more of the following: auditory prostheses; visual devices (e.g., bionic eyes); visual prostheses (e.g., retinal implants); sensors; cardiac pacemakers; drug delivery systems; defibrillators; functional electrical stimulation devices; catheters; brain implants; seizure devices (e.g., devices for monitoring and/or treating epileptic events); sleep apnea devices; electroporation; pain relief devices; etc. The concepts described herein and/or variations thereof can be applied to any of a variety of non-invasive devices configured to apply vibrational stimulation signals to the recipient's body in response to control signals (e.g., generated by the medical device; received from an external component). For example, the device can be recreational and configured to provide the vibrations for the enjoyment of the recipient. For another example, the device can be therapeutic and configured to provide vibrations that are efficacious for alleviating at least one condition of a medical malady (e.g., vertigo; motion sickness; motor disfunction such as Parkinson's disease).

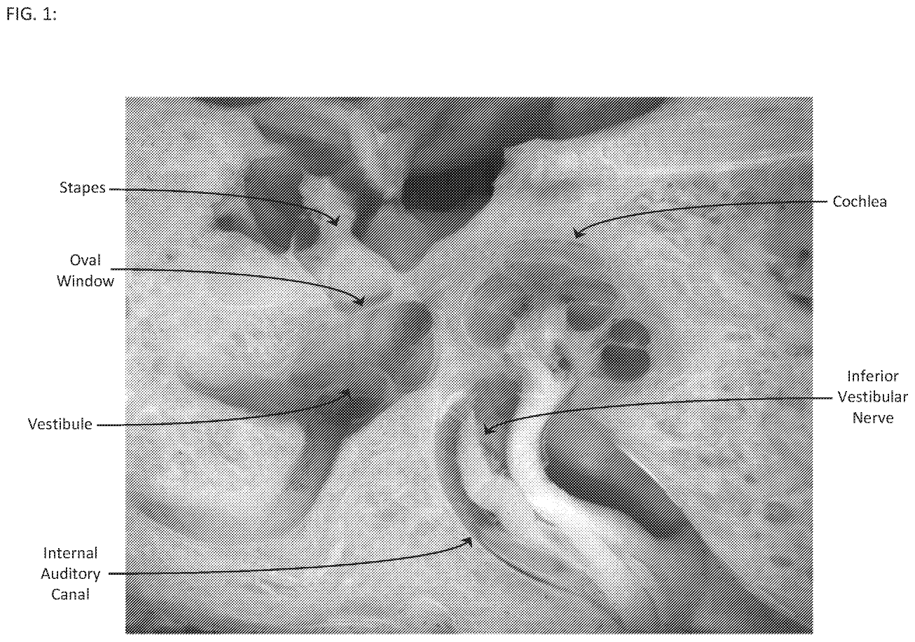

FIG. 1 shows a cross-sectional view cut in the mid-modiolar axial plane of the vestibular system in accordance with certain implementations described herein. The vestibular system includes the vestibule (e.g., vestibular cavity) that houses the three semicircular canals (anterior, posterior, and horizontal) and the otolithic organs (saccule and utricle). The three semi-circular canals are arranged substantially orthogonal to each other and are filled with endolymph fluid. Upon rotation of the head with a component of motion in the appropriate direction, movement of the fluid within the canal is detected by hair bundles connected to hair cells, and stimulation of the hair cells cause by the fluid movement produces a corresponding neural signal in nerve fibers.

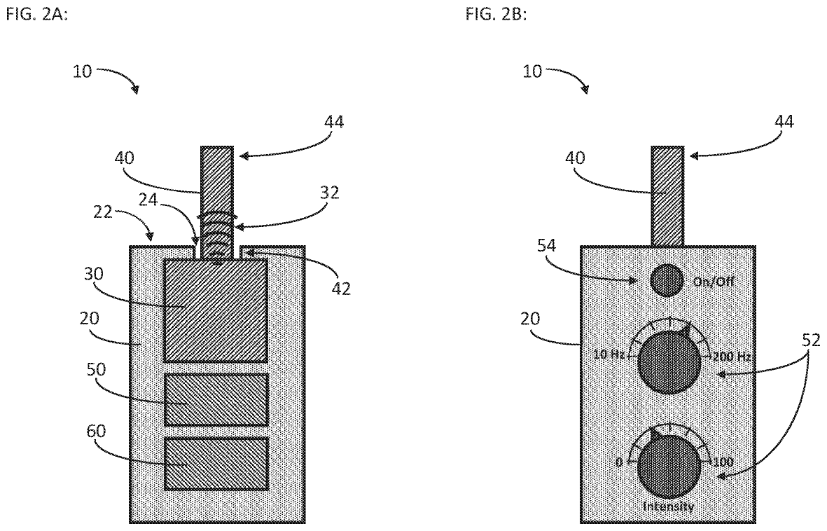

FIGS. 2A and 2B schematically illustrate a cross-sectional view and a side view, respectively, of an example apparatus 10 (e.g., vibrator; vibration generator) in accordance with certain implementations described herein. The apparatus 10 comprises a housing 20 configured to be held in a recipient's hand. The housing 20 contains at least one actuator 30 contained within the housing 20, the at least one actuator 30 configured to generate vibrations 32. The apparatus 10 further comprises at least one element 40 in mechanical communication with the at least one actuator 30 and extending from an outer surface 22 of the housing 20. The at least one element 40 is configured to receive the vibrations 32 from the at least one actuator 30, to be pressed against a portion of the recipient's head (not shown) by a recipient-generated force, and to transmit the vibrations 32 to the recipient's head.

In certain implementations, the housing 20 comprises metal, plastic, or a combination thereof. The housing 20 can have a size and shape configured to fit within a recipient's hand (e.g., handheld) during operation of the apparatus 10 (e.g., during application of the vibrations 32 to the recipient's head). In certain implementations, the portion of the outer surface 22 from which the at least one actuator 30 extends can be flat, curved, or contoured and can be configured to face the recipient during operation of the apparatus 10.

In certain implementations, the at least one actuator 30 comprises an electromechanical transducer or a piezoelectric transducer, and the vibrations 32 (e.g., sinusoidal vibrations) generated by the at least one actuator 30 and transmitted by the at least one element 40 to the recipient's head have a frequency in a range of 10 Hz to 200 Hz (e.g., in a range of 50 Hz to 200 Hz). For example, the vibrations 32 can have a single frequency (e.g., substantially pure tone) or multiple single frequencies in the range of 10 Hz to 200 Hz and no frequencies outside the range of 10 Hz to 200 Hz. For another example, the vibrations 32 can comprise one or more frequencies in the range of 10 Hz to 200 Hz and stochastic noise (e.g., high frequency noise; low frequency noise) outside the range of 10 Hz to 200 Hz. The vibrations 32 of certain implementations are configured to reduce (e.g., alleviate; suppress) at least one condition (e.g., symptom) of vertigo (e.g., dizziness; perceived movement or spinning that is not actually occurring; difficulty focusing at least one eye; reduced hearing in at least one ear; reduced balance; ringing in at least one ear; nausea; vomiting) or motion sickness (e.g., pallor; headache; cold sweating; fatigue; drowsiness; loss of appetite; increased salivation; nausea; vomiting). The vibrations 32 can comprise at least one frequency that is efficacious in suppressing at least one condition of vertigo or motion sickness. The vibrational frequency of the apparatus 10 can be tailored to the particular recipient expected to use the apparatus 10. For example, the vibrational frequency and/or amplitude can be set during a fitting procedure utilizing cervical vestibular evoked myogenic potential (cVEMP) testing, ocular vestibular evoked myogenic potential (oVEMP) testing, and/or auto vestibular evoked myogenic potential (auto VEMP) testing.

In certain implementations, the at least one element 40 (e.g., vibration conduit; shaft; tube) comprises a substantially rigid material (e.g., metal; plastic) having a substantially cylindrical shape with a width (e.g., diameter) in a range of 1 cm to 3 cm. The at least one element 40 can have a first end portion 42 in mechanical communication with the at least one actuator 30 and a second end portion 44 (e.g., headpiece; mouthpiece) spaced from the first end portion 42 and configured to be pressed against the portion of the recipient's head (e.g., against the recipient's forehead, temple, scalp, upper jaw, lower jaw, upper teeth, or lower teeth) by the recipient-generated force. For example, the recipient-generated force can comprise a manually-generated force (e.g., a force generated by the recipient's hand pressing the second end portion 44 against the portion of the recipient's head). For another example, the recipient-generated force can comprise a jaw-generated force (e.g., a bite force or pressure generated by the recipient's upper and lower teeth biting the second end portion 44).

In certain implementations, the at least one element 40 extends out of the housing 20 (see, e.g., FIGS. 2A and 2B), while in certain other implementations, the at least one element 40 is enclosed within the housing 20 (e.g., the housing 20 comprises an elongate portion containing the at least one element 40 and extending from the portion of the outer surface 22). The at least one element 40 can be vibrationally isolated from the housing 20 (e.g., by a gap 24 between the housing 20 and the at least one element 40).

In certain implementations, the apparatus 10 further comprises control circuitry 50 configured to control the at least one actuator 30 (e.g., to control one or more parameters of the vibrations 32). Examples of parameters of the vibrations 32 controlled by the control circuitry 50 include, but are not limited to: a frequency of the vibrations 32 (e.g., in a range of 10 Hz to 200 Hz); an amplitude (e.g., intensity) of the vibrations 32 (e.g., a percentage of a maximum amplitude of the at least one actuator 30, the percentage in a range of 0 to 100%); a time duration (e.g., period) during which the vibrations 32 are generated (e.g., in a range of 1 minute to 10 minutes). In certain implementations, the control circuitry 50 comprises a processor (e.g., microprocessor, application-specific integrated circuit, generalized integrated circuit programmed by software with computer executable instructions, microelectronic circuitry, microcontroller) configured to generate control signals and to provide the control signals to the at least one actuator 30. The at least one actuator 30 can be configured to respond to the control signals by adjusting one or more parameters of the vibrations 32. In certain implementations, the control circuitry 50 further comprises at least one storage device (e.g., at least one tangible or non-transitory computer readable storage medium; read only memory; random access memory; flash memory) in operative communication with the processor. The at least one storage device can be configured to store information (e.g., data; commands; values of one or more parameters of the vibrations 32 to be generated) accessible by the processor during operation. The at least one storage device can be encoded with software (e.g., a computer program downloaded as an application) comprising computer executable instructions for instructing the processor (e.g., executable data access logic, evaluation logic, and/or information outputting logic). In certain implementations, the processor executes the instructions of the software to provide functionality as described herein.

In certain implementations, one or more parameters of the vibrations 32 are programmed into the control circuitry 50 prior to operation of the at least one actuator 30 and are not adjustable in response to user input. In certain other implementations, one or more parameters of the vibrations 32 are adjustable in response to user input. For example, the apparatus 20 can further comprise at least one input interface 52 configured to generate input signals (e.g., from the recipient; from a medical practitioner), and the control circuitry 50 can be configured to, in response to the input signals, adjust and/or maintain at least one parameter of the vibrations 32 generated by the at least one actuator 30. Examples of parameters of the vibrations 32 adjusted and/or maintained by the control circuitry 50 in response to the input signals include, but are not limited to: a frequency of the vibrations 32 (e.g., in a range of 10 Hz to 200 Hz); an amplitude (e.g., intensity) of the vibrations 32 (e.g., a percentage of a maximum amplitude of the at least one actuator 30, the percentage in a range of 0 to 100%); a time duration (e.g., period) during which the vibrations 32 are generated (e.g., in a range of 1 minute to 10 minutes). While FIG. 2B schematically illustrates the at least one input interface 52 as comprising rotatable knobs (e.g., connected to potentiometers, which are not shown, of the control circuitry 50), other types of interfaces are also compatible with certain implementations described herein, examples of which include, but are not limited to: buttons; switches; touchscreen; microphone and voice-responsive circuitry. As another example, the at least one input interface 52 can comprise circuitry (e.g., an antenna) configured to receive wireless input signals (e.g., Bluetooth signals; WiFi signals) from a device separate from the apparatus 10 (e.g., smartphone, tablet, computing device).

In certain implementations, the control circuitry 50 further comprises a switch 54 configured to switch the at least one actuator 30 between an active state in which the at least one actuator 30 generates the vibrations 32 and an inactive state in which the at least one actuator 30 does not generate the vibrations 32. For example, in response to the switch 54, the control circuitry 50 can generate control signals which turn on or turn off the at least one actuator 30. In certain implementations, as schematically illustrated by FIG. 2B, the switch 54 comprises a button or other structure configured to be manually activated and deactivated by the recipient. In certain other implementations, the switch 54 is a part of the at least one element 40 or is in mechanical communication with the at least one element 40 and is configured to be activated by the at least one element 40 being pressed against the recipient's head. For example, the switch 54 can be activated by the at least one element 40 being manually pressed against the recipient's head (e.g., pressed by the recipient's hand against the recipient's forehead, temple, scalp, upper jaw, lower jaw, or teeth), and can be deactivated by the at least one element 40 being removed from the recipient's head. For another example, the switch 54 can be activated by the recipient biting the at least one element 40 between at least two opposing teeth of the recipient (e.g., with a bite force or pressure above a predetermined threshold) and can be deactivated by the recipient ceasing biting the at least one element 40 (e.g., the bite force or pressure below the predetermined threshold).

In certain implementations, the apparatus 10 further comprises a power source 60 in operative communication with (e.g., configured to provide power to) the at least one actuator 30 and/or the control circuitry 50. For example, the power source 60 can comprise an electrical power storage device (e.g., battery; capacitor), which can be rechargeable and configured to receive electrical power from an external source via a wired connection or a wireless (e.g., inductive) communication. For another example, the power source 60 can comprise a mechanism (e.g., a winding stem and spring; an accelerometer) configured to receive mechanical power from an external source (e.g., via winding or motion) and to provide power to the at least one actuator 30. The power source 60 can be configured to provide power in a range of 0.1 Watt to 10 Watts (e.g., 1 Watt to 5 Watts) to the at least one actuator 30 and/or the control circuitry 50.

In certain implementations, the apparatus 10 further comprises at least one output interface (not shown) configured to provide output signals (e.g., to the recipient; to the medical practitioner) indicative of information regarding the operation of the apparatus 10. For example, the output signals can be indicative of at least one current value of at least one parameter adjustable by the control circuitry 50, a charged state of the power source 60, and/or tracked (e.g., historical) usage of the apparatus 10. Examples of the at least one output interface include but are not limited to: a speaker configured to generate audio signals; an LED or LCD display configured to generate visual signals; a haptic motor configured to generate vibrations or other tactile signals. As another example, the at least one output interface can comprise circuitry (e.g., an antenna) configured to transmit wireless output signals (e.g., Bluetooth signals; WiFi signals) to a device separate from the apparatus 10 (e.g., smartphone, tablet, computing device). In certain implementations, the apparatus 10 comprises a user interface (e.g., touchscreen; transceiver antenna) configured to operate as both the at least one input interface 52 and the at least one output interface.

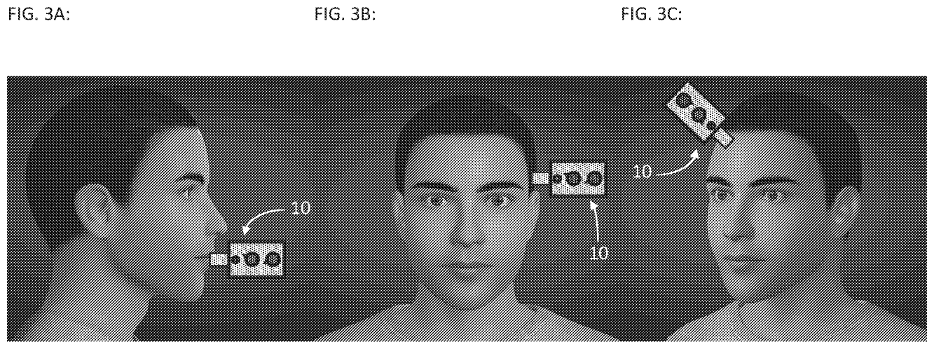

FIGS. 3A-3C schematically illustrate the apparatus 10 pressed against various example portions of the recipient's head in accordance with certain implementations described herein. As shown in FIG. 3A, the at least one element 40 of the apparatus 10 is pressed against the recipient's upper teeth and/or lower teeth (e.g., comprising one or more front teeth). For example, the at least one element 40 can be bitten by the recipient to apply a bite force to the at least one actuator 40. By avoiding vibrational losses via the skin, vibration conduction from the apparatus 10 through the teeth to the recipient's vestibular system can be more efficient than through the skin, so having the at least one element 40 in direct contact with the recipient's teeth can be more beneficial and/or efficient.

As shown in FIG. 3B, the at least one element 40 is pressed against the recipient's temple by a recipient-generated force (e.g., manually by the recipient). As shown in FIG. 3C, the at least one element 40 is pressed against the recipient's forehead. In certain implementations, the at least one element 40 is pressed against a location at a plane of substantial bilateral symmetry of the recipient's head (e.g., manually by the recipient) such that the vibrations 32 are transmitted from the at least one element 40 simultaneously and substantially equally (e.g., balanced) to bilateral portions of the recipient's vestibular system. For example, as shown in FIGS. 3A and 3C, the at least one element 40 can be pressed against one or more of the recipient's front teeth or against a portion of the forehead, respectively, that is substantially equally spaced from the vestibule at opposite sides of the recipient's head.

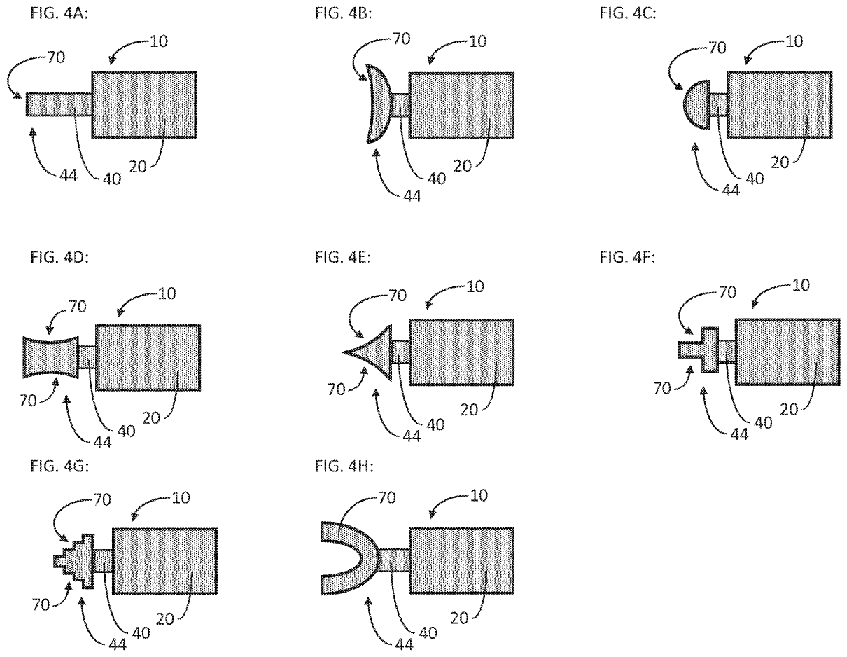

FIGS. 4A-4G schematically illustrate side views of various example apparatus 10 having various second end portions 44 of the at least one element 40 compatible with certain implementations described herein. The second end portion 44 can comprise at least one surface 70 configured to provide sufficient contact with the portion of the recipient's head to facilitate efficient transfer of the vibrations 32 from the at least one actuator 30 to the recipient's head. For example, the at least one surface 70 can be configured to substantially match a contour of the portion of the recipient's head (e.g., the recipient's forehead, temple, scalp, upper jaw, or lower jaw). For another example, the at least one surface 70 can be configured to have a shape similar to that of a bone conduction headphone.

FIGS. 4A-4C show the second end portion 44 comprising a headpiece in accordance with certain implementations described herein. As shown in FIG. 4A, the surface 70 can be substantially flat to provide sufficient contact while being held substantially perpendicular to the surface of the portion of the recipient's head. As shown in FIG. 4B, the surface 70 can be substantially concave to provide sufficient contact by conforming to a convex portion of the recipient's head. As shown in FIG. 4C, the surface 70 can be substantially convex to provide sufficient contact while being held at a range of angles relative to a direction perpendicular to the surface of the portion of the recipient's head. The area of the surface 70 in contact with the recipient's head can be in a range of 0.5 cm² to 20 cm².

FIGS. 4D-4G show the second end portion 44 comprising a mouthpiece in accordance with certain implementations described herein. As shown in FIGS. 4D-4G, the at least one surface 70 can be configured to be bitten by the recipient and to provide sufficient contact with the recipient's upper and lower teeth. For example, the at least one surface 70 can be configured to substantially match a contour of the portion of the recipient's upper teeth or lower teeth. As shown in FIG. 4D, the at least one surface 70 can comprise two concave surfaces 70 that are configured to be pressed against an occlusal surface of at least one tooth. As shown in FIG. 4E, the at least one surface 70 can comprise two concave surfaces 70 that are configured to be pressed against an occlusal surface and a mesial surface of at least one tooth. As shown in FIG. 4F, the at least one surface 70 can comprise two pairs of substantially flat surfaces 70 that are configured to be pressed against an occlusal surface and a mesial surface of at least one tooth. As shown in FIG. 4G, the at least one surface can comprise more than two pairs of surfaces 70 that are configured to be pressed against an occlusal surface and a mesial surface of at least one tooth. The more than two pairs of surfaces 70 can provide more comfort and/or flexibility by allowing the recipient to choose for larger or smaller distances between the upper teeth and lower teeth. In certain other implementations, the second end portion 44 can be configured to be pressed against a distal surface, buccal surface, and/or lingual surface of at least one tooth.

FIG. 4H schematically illustrates a top view of an example apparatus 10 having a second end portion 44 comprising a mouthpiece in accordance with certain implementations described herein. The example second end portion 44 of FIG. 4H is compatible with the example second end portions 44 of FIGS. 4D-4G (e.g., the top view of FIG. 4H is along a direction substantially perpendicular to the direction of the side views of FIGS. 4D-4G). The mouthpiece can be substantially planar and curved to substantially match at least a portion of the bite arch of the recipient.

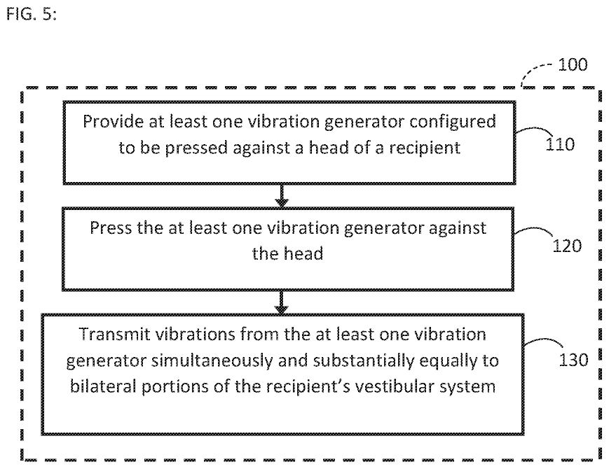

FIG. 5 is a flow diagram of an example method 100 in accordance with certain implementations described herein. While the method 100 is described by referring to some of the structures of the example apparatus 10 described herein, other apparatus and systems with other configurations of components can also be used to perform the method 100 in accordance with certain implementations described herein.

In an operational block 110, the method 100 comprises providing at least one vibration generator (e.g., apparatus 10 comprising at least one actuator 30 and at least one element 40) configured to be pressed against a head of a recipient.

In an operational block 120, the method 100 further comprises pressing the at least one vibration generator against the head. For example, said pressing the at least one vibration generator against the head can comprise manually pressing the at least one vibration generator against the recipient's forehead, temple, scalp, upper jaw, or lower jaw. For another example, said pressing the at least one vibration generator against the head can comprise biting the at least one vibration generator between at least two opposing teeth of the recipient.

In an operational block 130, the method 100 further comprises, while the at least one vibration generator is pressed against the head, transmit vibrations from the at least one vibration generator (e.g., vibrations 32 from the at least one actuator 30 via the at least one element 40) simultaneously and substantially equally to bilateral portions of the recipient's vestibular system. For example, the vibrations can comprise at least one frequency that is efficacious in suppressing at least one condition (e.g., symptom) of vertigo or motion sickness.

For example, upon a recipient feeling discomfort or other condition of vertigo or motion sickness (e.g., in a car or boat), the recipient can grab the apparatus 10 (e.g., from a pocket, purse, or backpack), place the second end portion 44 of the apparatus 10 between the recipient's upper and lower teeth, and activate the apparatus 10 to transmit the vibrations 32 to the recipient's head for a stimulation time period (e.g., in a range of 30 seconds to 5 minutes). After the stimulation time period has ended, the recipient can remove the apparatus 10 (e.g., return the apparatus 10 back to the pocket, purse, or backpack).

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of treating vertigo or motion sickness, various implementations described herein can be incorporated in a variety of other suitable devices, methods, and contexts. More generally, as can be appreciated, certain implementations described herein can be used in a variety of medical device contexts.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus comprising:
a housing configured to be held in a recipient's hand;
at least one actuator contained within the housing, the at least one actuator configured to generate vibrations; and
at least one element in mechanical communication with the at least one actuator and extending from a portion of an outer surface of the housing, the at least one element configured to receive the vibrations from the at least one actuator, to be pressed against a portion of the recipient's head by a recipient-generated force, and to transmit the vibrations to the recipient's head.

2. The apparatus of claim 1, wherein the at least one actuator comprises an electromechanical transducer.

3. The apparatus of claim 1, wherein the vibrations have a frequency in a range of 10 Hz to 200 Hz.

4. (canceled)

5. The apparatus of claim 1, wherein the at least one element is configured to be manually pressed against the recipient's forehead, temple, scalp, upper jaw, or lower jaw.

6. The apparatus of claim 5, wherein the recipient-generated force comprises a manually-generated force.

7. The apparatus of claim 1, wherein the at least one element is configured to be pressed against the recipient's upper teeth.

8. The apparatus of claim 7, wherein the recipient-generated force comprises a jaw-generated force.

9. (canceled)

10. The apparatus of claim 1, further comprising:
control circuitry configured to control the at least one actuator; and
a power source in operative communication with the at least one actuator and/or the control circuitry.

11. The apparatus of claim 10, wherein the apparatus further comprises at least one interface configured to generate input signals in response to input from the recipient or from a practitioner, the control circuitry configured to control a frequency and/or an amplitude of the vibrations generated by the at least one actuator in response to the input signals.

12. The apparatus of claim 10, wherein the control circuitry comprises:
a processor configured to generate control signals and to provide the control signals to the at least one actuator; and
at least one storage device in operative communication with the processor, the at least one storage device configured to store values of one or more parameters of the vibrations to be generated by the at least one actuator.

13. The apparatus of claim 1, wherein the vibrations are configured to reduce at least one condition of vertigo or motion sickness.

14. An apparatus comprising:
a handheld vibrator configured to generate vibrations in response to the vibrator being pressed against a recipient's head and to not generate the vibrations in response to the vibrator not being pressed against the recipient's head, the vibrator comprising a switch configured to switch the vibrator between an active state in which the vibrator generates the vibrations and an inactive state in which the vibrator does not generate the vibrations.

15. The apparatus of claim 14, wherein the vibrations are configured to reduce at least one condition of vertigo or motion sickness.

16. The apparatus of claim 14, wherein the vibrator comprises:
a body comprising at least one electromechanical transducer; and
at least one vibration conduit in mechanical communication with the at least one electromechanical transducer, the at least one vibration conduit configured to be pressed against a location at a plane of substantial bilateral symmetry of the recipient's head such that the vibrations are transmitted from the at least one vibration conduit simultaneously and substantially equally to bilateral portions of the recipient's vestibular system.

17. The apparatus of claim 16, wherein the at least one vibration conduit is configured to be pressed against the recipient's forehead, temple, scalp, upper jaw, or lower jaw.

18. (canceled)

19. (canceled)

20. The apparatus of claim 16, wherein the at least one vibration conduit is configured to be pressed against the recipient's teeth.

21. The apparatus of claim 20, wherein the vibrator comprises a mouthpiece configured to be placed between at least two opposing teeth of the recipient.

22. (canceled)

23. (canceled)

24. (canceled)

25. (canceled)

26. A method comprising:
providing at least one vibration generator configured to be pressed against a head of a recipient;
pressing the at least one vibration generator against the head; and
while the at least one vibration generator is pressed against the head, transmitting vibrations from the at least one vibration generator simultaneously and substantially equally to bilateral portions of the recipient's vestibular system.

27. The method of claim 26, wherein said pressing the at least one vibration generator against the head comprises manually pressing the at least one vibration generator against the recipient's forehead, temple, scalp, upper jaw, or lower jaw.

28. The method of claim 26, wherein said pressing the at least one vibration generator against the head comprises biting the at least one vibration generator between at least two opposing teeth of the recipient.

29. (canceled)
